(19) United States
(12) Patent Application Publication
(10) Pub. No.: US 2015/0044529 A1
(43) Pub. Date: Feb. 12, 2015

(54) RECHARGEABLE BATTERY

(71) Applicant: Samsung SDI Co., Ltd., Yongin-si (KR)

(72) Inventor: Ji-Won Yun, Yongin-si (KR)

(73) Assignee: Samsung SDI Co., Ltd., Yongin-si (KR)

(21) Appl. No.: 14/170,948

(22) Filed: Feb. 3, 2014

(30) Foreign Application Priority Data
Aug. 7, 2013 (KR) 10-2013-0093812

(51) Int. Cl. H01M 2/36

(52) U.S. Cl. CPC H01M 2/361; H01M 2/362
USPC 429/72

(57) ABSTRACT

A rechargeable battery is disclosed. In one aspect, the rechargeable battery includes an electrode assembly, a casing having an opening and housing the electrode assembly, a cap plate covering the opening of the casing and including a first injection hole and a first induction hole spaced apart from the first injection hole. The rechargeable battery also includes an insulating casing including a body contacting the electrode assembly and a blocking member protruding from the body. The insulating casing forms a space between the cap plate and the body and the blocking member divides the space into a first space fluidly connected to the first injection hole and a second space fluidly connected to the first induction hole.

### CROSS-REFERENCE TO RELATED APPLICATIONS

This application claims priority to and the benefit of Korean Patent Application No. 10-2013-0093812 filed in the Korean Intellectual Property Office on Aug. 7, 2013, the entire contents of which are incorporated herein by reference.

### BACKGROUND

1. Field

The described technology generally relates to a rechargeable battery, and more particularly, to a rechargeable battery having an improved electrolyte solution injection structure.

2. Description of the Related Technology

Rechargeable batteries can be repeatedly charged and discharged, unlike primary batteries which cannot be recharged. Low-capacity rechargeable batteries can be used in small and portable electronic devices, such as mobile phones, laptop computers, and camcorders, while high-capacity rechargeable batteries can be used as a power source for driving the motor of a vehicle such as an electric bicycle, a scooter, an electric vehicle, or a fork lift.

The standard rechargeable battery includes an electrode assembly formed by stacking a positive electrode and a negative electrode with a separator interposed therebetween and winding the stacked structure in a jelly roll form. Such a battery also typically includes a casing housing the electrode assembly and an electrolyte solution, a cap plate sealing an opening the casing, an electrode terminal installed in the cap plate and electrically connected to the electrode assembly, and an insulating casing interposed between the electrode assembly and the cap plate.

### SUMMARY OF CERTAIN INVENTIVE ASPECTS

One inventive aspect is a rechargeable battery having an electrolyte solution injection structure capable of supplying an electrolyte solution to an electrode assembly rapidly and stably.

Another aspect is a rechargeable battery, including an electrode assembly, a casing having an opening and housing the electrode assembly, a cap plate covering the opening of the casing and including a first injection hole and a first induction hole spaced apart from the first injection hole. The rechargeable battery also includes an insulating casing including a body contacting the electrode assembly and a blocking member protruding from the body. The blocking member dividing a space between the cap plate and the body into a first space fluidly connected to the first injection hole and a second space fluidly connected to the first induction hole.

The insulating casing may further include a second injection hole formed in the body and located in the first space and a second induction hole formed in the body and located in the second space.

The insulating casing may further include a discharge hole formed between the second injection hole and the blocking member.

The electrolyte solution may flow into the first space through the first injection hole, the electrolyte solution may then be supplied from the first space to the interior of the casing through the second injection hole, the electrolyte solution within the casing may rotate clockwise or counterclockwise within the casing and may be impregnated into the electrode assembly, and the impregnated electrolyte solution may then flow into the second space.

The rechargeable battery may further include a first sealing plug substantially sealing the first injection hole and a second sealing plug substantially sealing the first induction hole. After the electrolyte solution flows into the second space, the first injection hole may be substantially sealed with the first sealing plug and the first induction hole may be substantially sealed with the second sealing plug.

The width of the blocking member may be substantially the same as the width of the body and the height of the blocking member may be substantially the same as or greater than the distance between the body and the cap plate.

The cross-section of the blocking member may have a substantially quadrangular shape.

The blocking member may have a substantially curved shape and the blocking member may be curved towards the second induction hole.

The cap plate may include a fixing groove and the blocking member may be inserted into the fixing groove.

The rechargeable battery may further include an electrode terminal installed in the cap plate and a lead tab protruding from one end of the electrode assembly and electrically connected to the electrode terminal through the insulating casing.

The electrode terminal may be installed between the first injection hole and the first induction hole and the lead tab may be formed between the second injection hole and the second induction hole.

The blocking member can substantially prevent the electrolyte solution from directly flowing from the first space to the second space.

Furthermore, the width of the blocking member may be substantially the same as the width of the body and the height of the blocking member may be less than the distance between the body and the cap plate.

According to at least one embodiment, an electrolyte solution can be supplied to the electrode assembly stably and quickly.

### BRIEF DESCRIPTION OF THE DRAWINGS

FIG. 1 is an exploded perspective view of a rechargeable battery in accordance with a first exemplary embodiment of the described technology.

FIG. 2 is a cross-sectional view taken along line II-II of FIG. 1.

FIGS. 3A to 3C are diagrams schematically showing the process of injecting an electrolyte solution into a casing in accordance with the first exemplary embodiment.

FIG. 4 is an exploded perspective view of a rechargeable battery in accordance with a second exemplary embodiment.

FIG. 5 is a cross-sectional view taken along line V-V of FIG. 4.

FIG. 6 is an exploded perspective view of a rechargeable battery in accordance with a third exemplary embodiment.

### DETAILED DESCRIPTION OF CERTAIN INVENTIVE EMBODIMENTS

In order for the typical rechargeable battery to operate smoothly, an electrode assembly needs to be sufficiently impregnated into an electrolyte solution. The electrolyte solution can be supplied to the casing of a rechargeable battery through an electrolyte injection hole formed in the cap plate of the casing. The electrolyte solution supplied to the electrolyte injection hole can flow into the casing in which the electrode assembly is installed via a space between the cap plate and the insulating casing.

If the quantity of the supplied electrolyte solution is greater than the quantity of the electrolyte solution impregnated into the electrode assembly, a problem can occur in which the time taken to supply the electrolyte solution increases because the electrolyte solution accumulated in the space between the insulating casing and the cap plate is not supplied to the electrode assembly but is instead discharged from the casing through the cap plate.

The described technology will be described more fully hereinafter with reference to the accompanying drawings, in which exemplary embodiments of the described technology are shown. As those skilled in the art would realize, the described embodiments may be modified in various different ways, all without departing from the spirit or scope of the described technology. The drawings and description are to be regarded as illustrative in nature and not restrictive. Like reference numerals designate like elements throughout the specification.

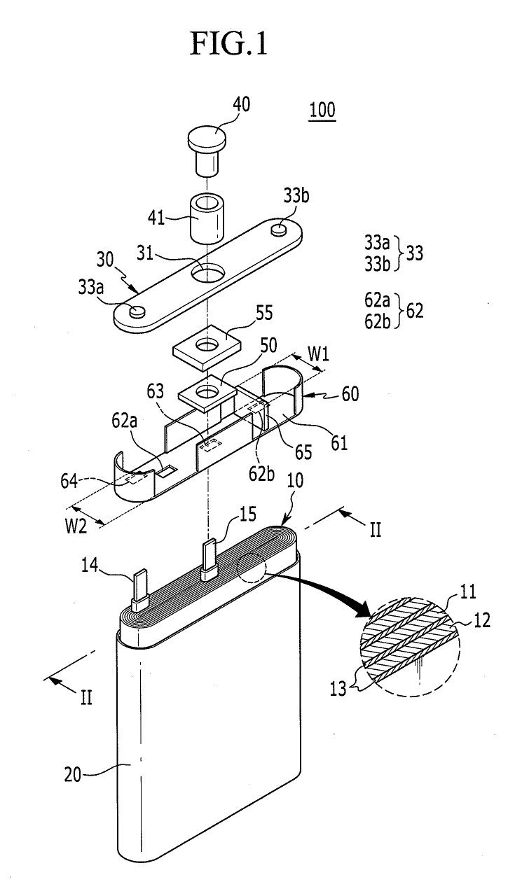

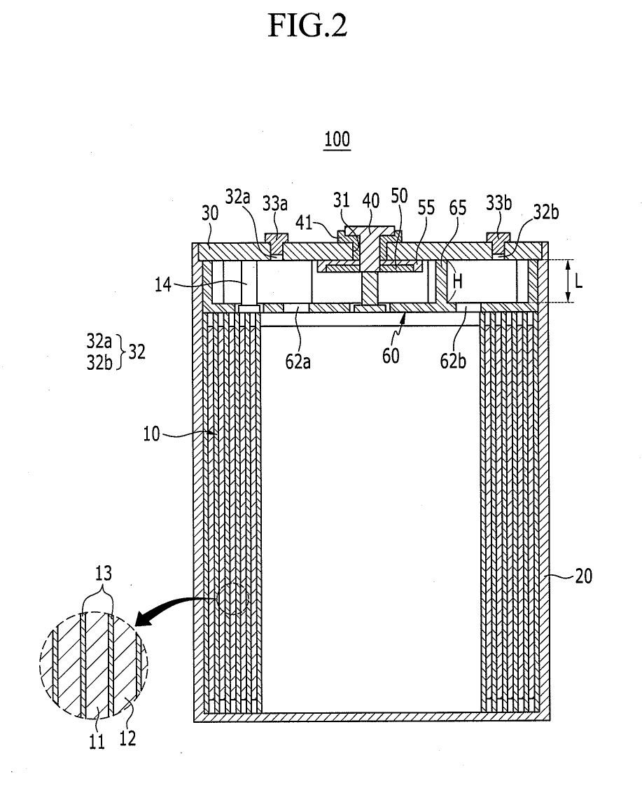

FIG. 1 is an exploded perspective view of a rechargeable battery in accordance with a first exemplary embodiment of the described technology, and FIG. 2 is a cross-sectional view taken along line II-II of FIG. 1.

Referring to FIGS. 1 and 2, the rechargeable battery 100 includes an electrode assembly 10, a casing 20 housing the electrode assembly, a cap plate 30 covering the opening of the casing 20, an electrode terminal 40 installed in the cap plate 30, a terminal plate 50 combined with the electrode terminal 40, and an insulating casing 60 interposed between the cap plate 30 and the electrode assembly 10.

The electrode assembly 10 is formed by stacking a positive electrode 11 and a negative electrode 12 with a separator 13, that is, an electrical insulator, interposed therebetween and spirally winding the positive and the negative electrodes 11 and 12 in a jelly roll form.

Furthermore, the electrode assembly 10 includes a positive lead tab 14 connected to the positive electrode 11 and a negative lead tab 15 connected to the negative electrode 12.

The positive lead tab 14 may be connected to the bottom of the cap plate 30 that faces the electrode assembly 10 by being welded thereto.

The casing 20 may be made of a conductive material including aluminum or an aluminum alloy.

Accordingly, the casing 20 is electrically connected to the positive electrode 11 of the electrode assembly 10 via the cap plate 30, and thus is capable of functioning as a positive terminal.

The electrode terminal 40 is fixed to a terminal hole 31 formed in the cap plate 30.

An insulating gasket 41 is formed between the terminal hole 31 and the electrode terminal 40 and electrically insulates the terminal hole 31 from the electrode terminal 40. The insulating gasket 41 also substantially seals the terminal hole 31 and the electrode terminal 40.

Furthermore, the terminal plate 50 is attached to one end of the electrode terminal 40 that faces the electrode assembly 10 and an insulating plate 55 is formed between the terminal plate 50 and the cap plate 30.

Accordingly, the cap plate 30 is electrically insulated from the terminal plate 50 due to the insulating plate 55. The insulating plate 55 substantially seals the cap plate 30 and the terminal plate 50.

The negative lead tab 15 is connected to the bottom of the terminal plate 50 and can be connected to one end of the electrode terminal 40 that faces the electrode assembly 10 by being welded thereto.

Accordingly, the electrode terminal 40 provided in the terminal hole 31 of the cap plate 30 is electrically connected to the negative electrode 12 of the electrode assembly 10, and thus is capable of functioning as a negative terminal.

The cap plate 30 can include a first electrolyte solution hole 32.

The first electrolyte solution hole 32 includes a first electrolyte solution injection hole (or first injection hole) 32a which can have an electrolyte solution EL injected therethrough and a first electrolyte solution induction hole (or first induction hole) 32b spaced apart from the first electrolyte solution injection hole 32a and configured to induce the electrolyte solution EL into the casing 20.

The first electrolyte solution injection hole 32a and the first electrolyte solution induction hole 32b can be formed with the electrode terminal 40 interposed therebetween.

Furthermore, the first electrolyte solution hole 32 can be substantially sealed by a sealing plug 33 after the electrolyte solution EL is supplied to the inside of the casing 20.

The sealing plug 33 includes a first sealing plug 33a which substantially seals the first electrolyte solution injection hole 32a and a second sealing plug 33b which substantially seals the first electrolyte solution induction hole 32b.

The insulating casing 60 is formed between the electrode assembly 10 and the terminal plate 50 and electrically insulates the electrode assembly 10 from the terminal plate 50.

More particularly, the insulating casing 60 includes a body 61, a second electrolyte solution hole 62 which can have the electrolyte solution EL pass therethrough, first and second tab holes 63 and 64 through which the positive lead tab 14 and the negative lead tab 15 penetrate, and an electrolyte solution blocking member (or blocking member) 65.

The body 61 of the insulating casing 60 has a substantially thin sheet shape and is formed to contact the electrode assembly 10 with a space interposed between the body 61 and the cap plate 30.

As described above, in accordance with the present exemplary embodiment, the space is formed between the cap plate 30 and the body 61 of the insulating casing 60.

The second electrolyte solution hole 62 includes a second electrolyte solution injection hole (or second injection hole) 62a, which can have the electrolyte solution EL supplied to the first electrolyte solution injection hole 32a discharged therethrough, and a second electrolyte solution induction hole (or second induction hole) 62b fluidly connected to (hereinafter to be interchangeably used with “being in fluid communication with”) the first electrolyte solution induction hole 32b.

The negative lead tab 15 may be formed between the second electrolyte solution injection hole 62a and the second electrolyte solution induction hole 62b.

In accordance with the present exemplary embodiment, the positive lead tab 14 is attached to the cap plate 30 through the second tab hole 64 and the negative lead tab 15 is attached to the terminal plate 50 through the first tab hole 63.

Furthermore, the electrolyte solution blocking member 65 protrudes from the body 61 of the insulating casing 60.

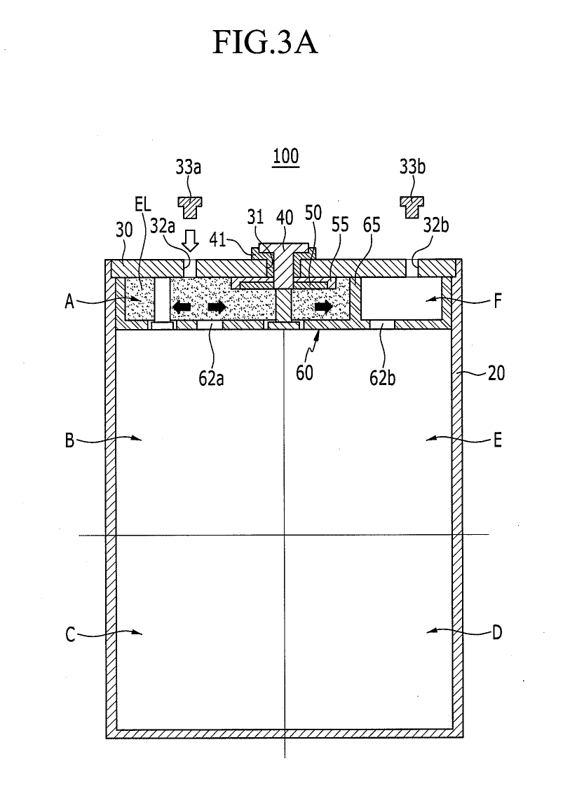

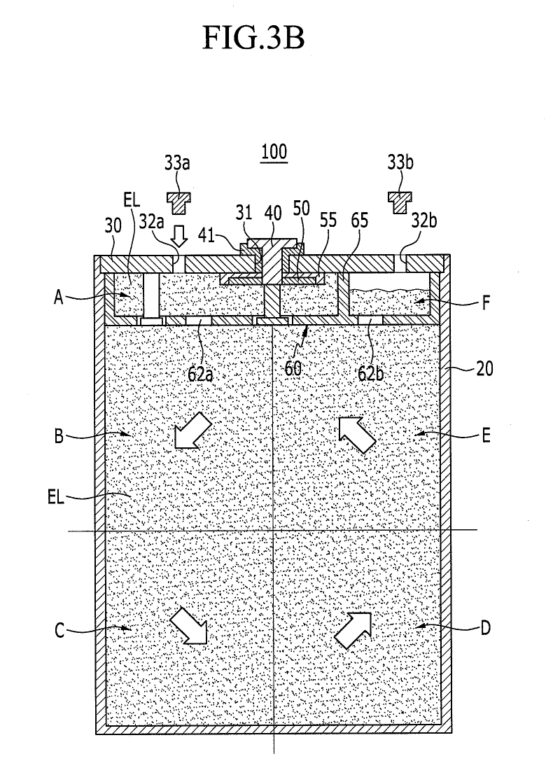

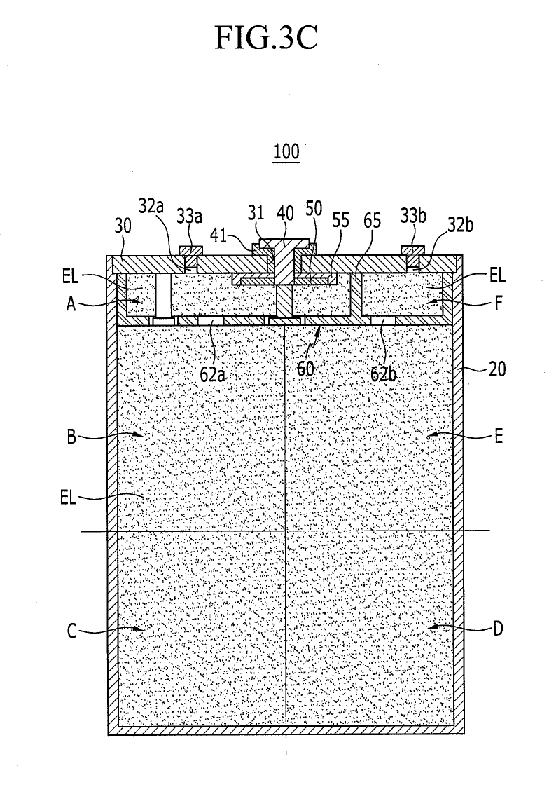

As shown in FIG. 3, the space between the cap plate 30 and the body 61 of the insulating casing 60 is divided into two spaces by way of the electrolyte solution blocking member 65. The space between the cap plate 30 and the body 61 of the insulating casing 60 includes a first space A fluidly connected to the first electrolyte solution injection hole 32a and a second space F fluidly connected to the first electrolyte solution induction hole 32b.

In accordance with the present exemplary embodiment, the electrolyte solution blocking member 65 can have a structure for substantially preventing the direct flow of a fluid between the first space A and the second space F.

For example, the electrolyte solution blocking member 65 can have a substantially cuboid shape with a substantially quadrangular cross-sectional shape. The electrolyte solution blocking member 65 can be protruded from the body 61 of the insulating casing 60. The width W1 (i.e., the width of the cuboid) of the electrolyte solution blocking member 65 can be substantially the same as the width W2 of the body 61 of the insulating casing 60.

Furthermore, the electrolyte solution blocking member 65 can have a height H (i.e., the height of the cuboid) that is substantially equal to the distance L between the body 61 of the insulating casing 60 and the cap plate 30.

As shown in FIG. 1, the body 61 of the insulating casing 60 has approximately the same width W2 as the width W1 of the casing 20.

A pair of the opposing sides of the electrolyte solution blocking member 65 which face each other are closely adhered to a sidewall within the casing 20 and another face between the opposing sides contacts one surface of the cap plate 30 that faces the electrode assembly 10.

Accordingly, the first space A and the second space F can be substantially separated from each other by the electrolyte solution blocking member 65 so that the electrolyte solution EL can be substantially prevented from directly flowing between the first and second spaces A and F.

The height H of the electrolyte solution blocking member 65 has been illustrated as being substantially the same as the distance L between the body 61 of the insulating casing 60 and the cap plate 30, however, the described technology is not limited thereto. For example, the height H of the electrolyte solution blocking member 65 may be less than the distance L between the body 61 of the insulating casing 60 and the cap plate 30.

Furthermore, the second electrolyte solution injection hole 62a formed in the insulating casing 60 is placed in the first space A and the second electrolyte solution induction hole 62b formed in the insulating casing 60 is placed in the second space F.

Accordingly, the first electrolyte solution injection hole 32a and the second electrolyte solution injection hole 62a are fluidly connected via the first space A and the first electrolyte solution induction hole 32b and the second electrolyte solution induction hole 62b are fluidly connected via the second space F.

FIGS. 3A to 3C are diagrams schematically showing a process of injecting the electrolyte solution into the casing in accordance with the first exemplary embodiment.

Referring to FIGS. 3A to 3C, the interior of the rechargeable battery 100 can be divided into the first space A, the second space F separated from the first space A by way of the electrolyte solution blocking member 65, a third space B below the second electrolyte solution injection hole 62a, a fourth space C between the third space B and the bottom of the casing 20, a fifth space D which is adjacent to the fourth space C and located over the bottom of the casing 20, and a sixth space E between the fifth space D and the second space F.

In accordance with the present exemplary embodiment, the electrolyte solution EL supplied through the first electrolyte solution injection hole 32a flows into the first space A.

Here, the electrolyte solution EL initially does not flow into the third space B through the second electrolyte solution injection hole 62a and instead fills the first space A.

In accordance with the present exemplary embodiment, fluids are substantially prevented from directly flowing between the first space A and the second space F is due to the electrolyte solution blocking member 65, and thus the electrolyte solution EL in the first space A does not flow to the second space F. Accordingly, the electrolyte solution EL filled in the first space A can be substantially prevented from being externally discharged through the first electrolyte solution induction hole 32b fluidly connected to the second space F.

Furthermore, in accordance with the present exemplary embodiment, while the electrolyte solution EL is supplied to the first space A, the second sealing plug 33b is removed from the first electrolyte solution induction hole 32b, and thus, the second electrolyte solution induction hole 32b remains opened.

At this time, the electrolyte solution EL is injected into to the first space A under a pressure and flows to the third to sixth spaces B to E. The pressure of the electrolyte solution in the second space F is less than the pressure in each of the first space A and the third to sixth spaces B to E.

Accordingly, the electrolyte solution EL injected into the first space A flows into the second space F via the third to sixth spaces B to E due to the pressure difference between the first and second spaces A and F.

That is, in accordance with the present exemplary embodiment, the first and second electrolyte solution induction holes 32b and 62b are fluidly connected via the second space F and function to induce the electrolyte solution EL to smoothly flow into the third to sixth spaces B to E within the casing 20.

For example, the electrolyte solution EL supplied to the first space A can flow into the third space B through the second electrolyte solution injection hole 62a, the electrolyte solution EL can then flow from the third space B into the fourth space C, and can flow into the second space F through the second electrolyte solution induction hole 62b via the fifth space D and the sixth space E.

As shown in FIG. 3B, the electrolyte solution EL is rotates counterclockwise within the casing 20 and is then impregnated into the electrode assembly 10.

In accordance with the present exemplary embodiment, the electrolyte solution EL has been illustrated as rotating counterclockwise (i.e., the arrow direction in FIG. 3B), but the described technology is limited thereto. For example, the electrolyte solution EL may rotate clockwise within the casing 20 and then be impregnated into the electrode assembly 10.

Furthermore, in accordance with the present exemplary embodiment, after the electrolyte solution EL flows into the second space F and fills the second space F, the first electrolyte solution injection hole 32a and the first electrolyte solution induction hole 32b are respectively substantially sealed with the first and second sealing plugs 33a and 33b.

As a result, the electrolyte solution blocking member 65 substantially prevents the electrolyte solution EL from being discharged from the casing 20 without being supplied to the electrode assembly 10 within the casing 20. Accordingly, the electrolyte solution EL can be stably supplied to the interior of the casing 20 and then impregnated into the electrode assembly 10.

Furthermore, according to at least one embodiment, the time required for the electrolyte solution EL to be injected into the casing 20 can be reduced because the first electrolyte solution induction hole 32b and the second electrolyte solution induction hole 62b induce the electrolyte solution EL to rapidly flow into the casing 20.

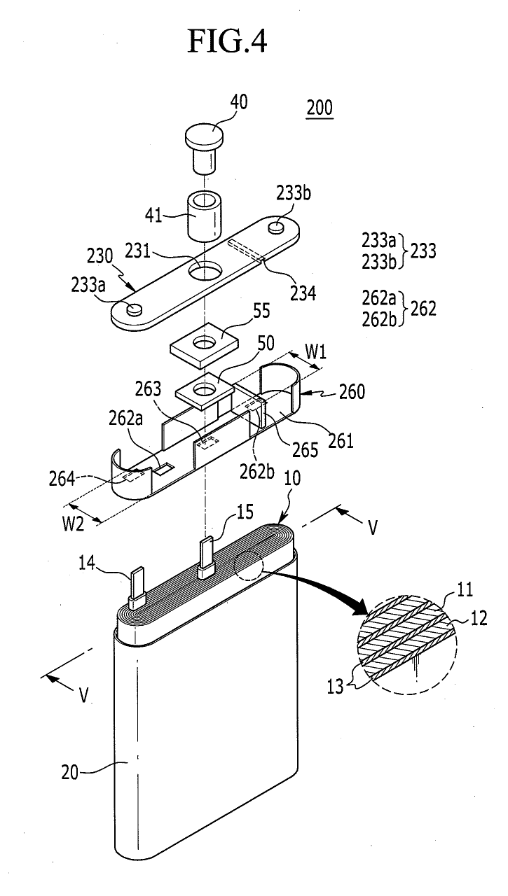

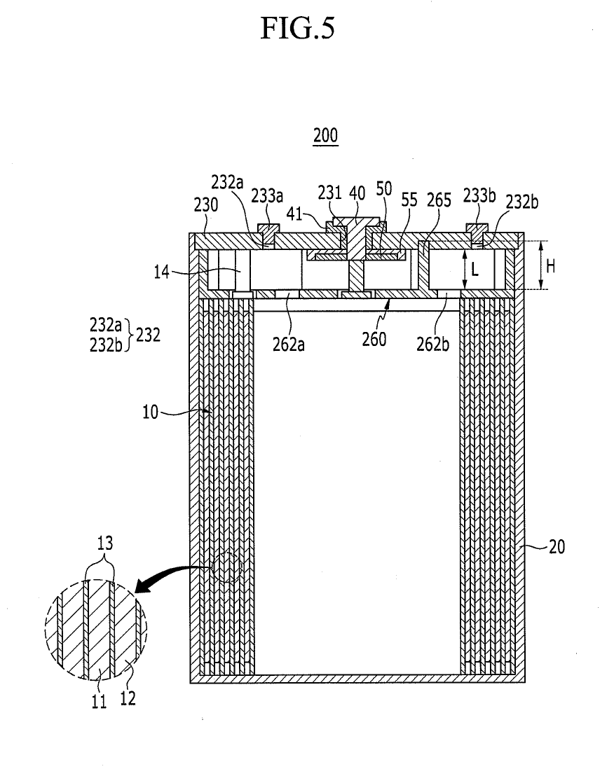

FIG. 4 is an exploded perspective view of a rechargeable battery in accordance with a second exemplary embodiment and FIG. 5 is a cross-sectional view taken along line V-V of FIG. 4.

Referring to FIGS. 4 and 5, the rechargeable battery 200 in accordance with the present exemplary embodiment has a substantially similar construction to the rechargeable battery 100 of the first exemplary embodiment except for the construction of a cap plate 230 and an insulating casing 260.

Therefore, detailed descriptions of the components similar to those of the rechargeable battery 100 of the first exemplary embodiment are omitted.

The cap plate 230 includes a terminal hole 231 in which the electrode terminal 40 is inserted, a first electrolyte solution hole 232 including a first electrolyte solution injection hole 232a and a first electrolyte solution induction hole 232b, a sealing plug 233 including a first sealing plug 233a and a second sealing plug 233b, and a fixing groove 234.

The cap plate 230 has substantially the same construction as the cap plate 30 of the rechargeable battery 100 of the first exemplary embodiment except for the inclusion of the fixing groove 234.

Therefore, detailed descriptions of the components similar to those of the cap plate 30 of the rechargeable battery 100 of the first exemplary embodiment are omitted.

The fixing groove 234 of the cap plate 230 is formed in one surface of the cap plate 230 which faces the electrode assembly 10.

Furthermore, the insulating casing 260 includes a body 261, a second electrolyte solution hole 262 including a second electrolyte solution injection hole 262a and a second electrolyte solution induction hole 262b, first and second tab holes 263 and 264 through which the negative and positive lead tabs 15 and 14 are respectively penetrated, and an electrolyte solution blocking member 265.

The insulating casing 260 has substantially the same construction as the insulating casing 60 of the first exemplary embodiment except for the construction of the electrolyte solution blocking member 265.

Therefore, detailed descriptions of the same elements as those of the insulating casing 60 of the first exemplary embodiment are omitted.

The electrolyte solution blocking member 265 of the insulating casing 260 is inserted into the fixing groove 234 of the cap plate 230 and then fixed thereto.

More particularly, the electrolyte solution blocking member 265 has a substantially cuboid shape and has a substantially quadrangular cross-sectional shape. The electrolyte solution blocking member 265 protrudes from the body 261 of the insulating casing 260. The electrolyte solution blocking member 265 has substantially the same width W1 (i.e., the width of the cuboid) as the width W2 of the body 261 of the insulating casing 260.

Furthermore, the electrolyte solution blocking member 265 can have a height H (i.e., the height of the cuboid) greater than the distance L between the body 261 of the insulating casing 260 and the cap plate 230.

Accordingly, the insulating casing 260 can be stably fixed within the casing 20 because the electrolyte solution blocking member 265 is fixed to the fixing groove 234 formed in the cap plate 230.

Consequently, the electrolyte solution EL is substantially prevented from directly flowing from the first space A to the second space F (refer to FIG. 3A) because the cap plate 230 comes in contact with the electrolyte solution blocking member 265.

In accordance with the present exemplary embodiment, since the electrolyte solution blocking member 265 is inserted into and fixed to the fixing groove 234 formed in the cap plate 230, the area of the electrolyte solution blocking member 265 that comes in contact with the fixing groove 234 of the cap plate 230 is increased.

Accordingly, the electrolyte solution EL can be substantially prevented from directly flowing from the first space A to the second space F because the electrolyte solution blocking member 265 is inserted into the fixing groove 234 and since the contact area between the cap plate 230 and the electrolyte solution blocking member 265 is increased.

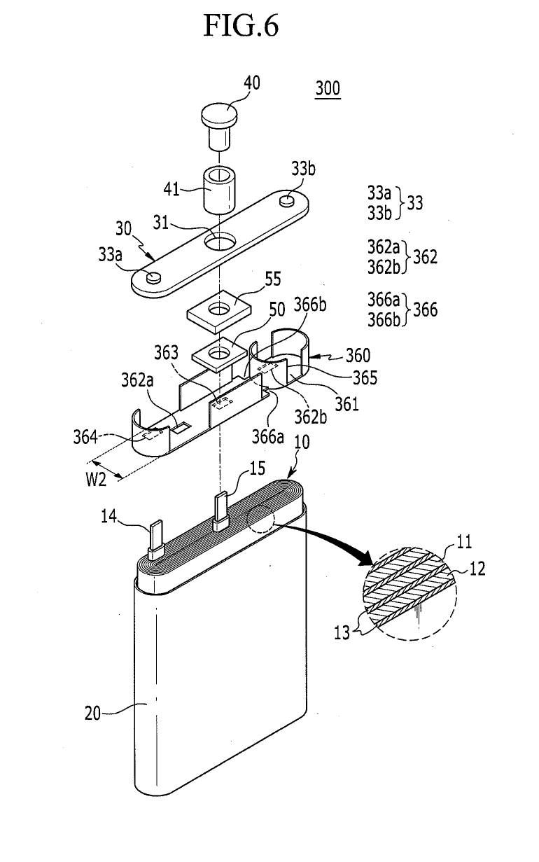

FIG. 6 is an exploded perspective view of a rechargeable battery in accordance with a third exemplary embodiment.

Referring to FIG. 6, the rechargeable battery 300 has substantially the same construction as the rechargeable battery 100 of the first exemplary embodiment except for the configuration of an insulating casing 360.

Therefore, detailed descriptions of the elements similar to those of the previous embodiments are omitted.

The insulating casing 360 includes a body 361, a second electrolyte solution hole 362 including a second electrolyte solution injection hole 362a and a second electrolyte solution induction hole 362b, first and second tab holes 363 and 364 through which the negative and positive lead tabs 15 and 14 are respectively penetrated, an electrolyte solution blocking member 365, and an electrolyte solution discharge hole 366.

The insulating casing 360 has substantially the same construction as the insulating casing 60 of the of the first exemplary embodiment except for the configuration of the electrolyte solution blocking member 365 and the inclusion of the electrolyte solution discharge hole 366.

Therefore, detailed descriptions of the elements similar to those of the insulating casing 60 of the first exemplary embodiment are omitted.

The electrolyte solution blocking member 365 can have a substantially curved shape curved towards the second electrolyte solution induction hole 362b.

Furthermore, the electrolyte solution discharge hole 366 can be formed between the second electrolyte solution injection hole 362a and the electrolyte solution blocking member 365.

The electrolyte solution discharge hole 366 includes a first electrolyte solution discharge hole (or a first discharge hole) 366a and a second electrolyte solution discharge hole (or a second discharge hole) 366b formed on opposing sides of the body 361 of the insulating casing 360.

More particularly, the first and second electrolyte solution discharge holes 366a and 366b including slot formed in opposing sides of the body where the electrolyte solution blocking member 365 meets the body 361 of the insulating casing 360.

Accordingly, the electrolyte solution EL can rapidly flow from the first space A to the inside of the casing 20 through the first and the second electrolyte solution discharge holes 366a and 366b in addition to the second electrolyte solution injection hole 362a.

Furthermore, in accordance with the present exemplary embodiment, the electrolyte solution EL filled in the first space A can flow along the curved outer surface of the electrolyte solution blocking member 365 and can be then efficiently supplied to the inside of the casing 20 via the first and second electrolyte solution discharge holes 366a and 366b connected to the outer surface of the electrolyte solution blocking member 365.

The outer surface of the electrolyte solution blocking member 365 is not limited to a curved shape.

Accordingly, the outer surface of the electrolyte solution blocking member 365 may have substantially the same shape as the outer surface of the electrolyte solution blocking member 65 of the rechargeable battery 100 of the first exemplary embodiment of or as the outer surface of the electrolyte solution blocking member 265 of the rechargeable battery 200 of the second exemplary embodiment.

According to some embodiments, the electrolyte solution blocking member 365 can have a curved shape and the height H of the electrolyte solution blocking member 365 can be greater than the distance L between the body 361 of the insulating casing 360 and the cap plate 30. In these cases, the cap plate 30 includes a fixing groove similar to the fixing groove 234 of the second exemplary embodiment, except, the fixing groove has a shape corresponding to the curved shape of the electrolyte solution blocking member 365.

While the described technology has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A rechargeable battery, comprising:
an electrode assembly;
a casing having an opening and housing the electrode assembly;
a cap plate covering the opening of the casing and having a first injection hole and a first induction hole spaced apart from each other; and
an insulating casing comprising i) a body contacting the electrode assembly and ii) a blocking member protruding from the body toward the cap plate,
wherein the insulating casing forms a space between the cap plate and the body, and
wherein the blocking member divides the space into i) a first space being in fluid communication with the first injection hole and ii) a second space being in fluid communication with the first induction hole.

2. The rechargeable battery of claim 1, wherein the insulating casing further comprises:
a second injection hole formed in the body and located in the first space; and
a second induction hole formed in the body and located in the second space.

3. The rechargeable battery of claim 2, wherein the insulating casing further comprises a discharge hole formed between the second injection hole and the blocking member.

4. The rechargeable battery of claim 1, further comprising:
a first sealing plug substantially sealing the first injection hole; and
a second sealing plug substantially sealing the first induction hole.

5. The rechargeable battery of claim 2, wherein the width of the blocking member is substantially equal to the width of the body and wherein the height of the blocking member is substantially equal to or greater than the distance between the body and the cap plate.

6. The rechargeable battery of claim 5, wherein a cross-section of the blocking member has a substantially quadrangular shape.

7. The rechargeable battery of claim 5, wherein the blocking member has a substantially curved shape and wherein the blocking member is curved towards the second induction hole.

8. The rechargeable battery of claim 5, wherein the cap plate further comprises a fixing groove and wherein the blocking member is inserted into the fixing groove.

9. The rechargeable battery of claim 2, further comprising:
an electrode terminal installed in the cap plate; and
a lead tab protruding from one end of the electrode assembly and electrically connected to the electrode terminal,
wherein the insulating casing further comprises a tab hole, and
wherein the lead tab extends through the tab hole.

10. The rechargeable battery of claim 9, wherein the electrode terminal is installed between the first injection hole and the first induction hole and wherein the lead tab is formed between the second injection hole and the second induction hole.

11. The rechargeable battery of claim 1, further comprising an electrolyte solution, wherein the blocking member is configured to substantially prevent the electrolyte solution from directly flowing from the first space to the second space.

12. The rechargeable battery of claim 1, wherein the width of the blocking member is substantially equal to the width of the body and wherein the height of the blocking member is less than the distance between the body and the cap plate.

13. A rechargeable battery, comprising:
an electrolyte solution;
an electrode assembly;
a casing having an opening and housing the electrode assembly and the electrolyte solution;
a cap plate covering the opening of the casing; and
an insulating casing comprising a blocking member and forming a space between the electrode assembly and the cap plate,
wherein the blocking member divides the space into a first space and a second space and is configured to substantially prevent a direct flow of the electrolyte solution between the first and second spaces.

14. The rechargeable battery of claim 13, wherein the cap plate comprises:
a first injection hole being in fluid communication with the first space; and
a first induction hole spaced apart from the first injection hole and being in fluid communication with the second space.

15. The rechargeable battery of claim 14, wherein the insulating casing further comprises:
a second injection hole formed in the body and located in the first space; and
a second induction hole formed in the body and located in the second space.

16. The rechargeable battery of claim 15, wherein the insulating casing further comprises a discharge hole formed between the second injection hole and the blocking member.

17. The rechargeable battery of claim 15, wherein the blocking member has a substantially curved shape and wherein the blocking member is curved towards the second induction hole.

18. The rechargeable battery of claim 13, wherein the width of the blocking member is substantially equal to the width of the body and wherein the height of the blocking member is substantially equal to or greater than the distance between the body and the cap plate.

19. The rechargeable battery of claim 13, further comprising:
an electrode terminal installed in the cap plate; and
a lead tab protruding from one end of the electrode assembly and electrically connected to the electrode terminal,
wherein the insulating casing further comprises a tab hole, and
wherein the lead tab extends through the tab hole.

20. The rechargeable battery of claim 13, wherein the width of the blocking member is substantially equal to the width of the body and wherein the height of the blocking member is less than the distance between the body and the cap plate.
